(19) United States
(12) Patent Application Publication
(10) Pub. No.: US 2015/0150143 A1
(43) Pub. Date: May 28, 2015

(54) SYSTEM AND METHOD FOR PROVIDING VIRTUAL DESKTOP INFRASTRUCTURE (VDI) SERVICE

(71) Applicant: Electronics and Telecommunications Research Institute, Daejeon (KR)

(72) Inventors: Dong-Hyuck IM, Daejeon (KR); Il-Gu JUNG, Daejeon (KR); Gi-Mun UM, Daejeon (KR); Won RYU, Seoul (KR)

(21) Appl. No.: 14/533,927

(22) Filed: Nov. 5, 2014

(30) Foreign Application Priority Data
Nov. 27, 2013 (KR) 10-2013-0145654

(51) Int. Cl. G06F 21/60; H04L 29/08

(52) U.S. Cl. CPC G06F 21/60; H04L 67/10
USPC 726/26

(57) ABSTRACT

A system for providing a virtual desktop infrastructure (VDI) service includes: a service provider configured to provide VDI service data to a client terminal; and a watermark inserter configured to insert a watermark into the VDI service data, in which the watermark comprises a watermark code for identifying a watermark and a terminal code for identifying a client terminal.

### CROSS-REFERENCE TO RELATED APPLICATION(S)

This application claims priority from Korean Patent Application No. 10-2013-0145654, filed on Nov. 27, 2013, in the Korean Intellectual Property Office, the entire disclosure of which is incorporated herein by reference for all purposes.

### BACKGROUND

1. Field

The following description relates to a virtual desktop infrastructure (VDI) service, and more particularly, to a security technology for preventing information leakage of the VDI service.

2. Description of the Related Art

Virtual Desktop Infrastructure (VDI) provides on-demand services to a user by centralizing applications and data, thereby enabling company information that used to be saved to PCs to be stored and managed in a server with high security to minimize leakage paths of such information. However, among leakage paths, photographing by using screen capturing, a camera, or a smartphone cannot be completely prevented. Although a solution may be used to prevent screen captures, there is also technology to evade anti-screen capture solutions, and various methods exist for capturing screenshots. Moreover, there are no solutions to prevent capturing screenshots using a camera or a smartphone. Accordingly, when documents are leaked by screen capturing or using a camera/smartphone in the VDI environment, there is a need for a security solution to trace a person suspected of the information leakage.

### SUMMARY

Disclosed is a technology for tracing a person suspected of leaking VDI service information.

According to an exemplary embodiment, there is provided a system for providing a virtual desktop infrastructure (VDI) service, which includes: a service provider configured to provide VDI service data to a client terminal; and a watermark inserter configured to insert a watermark into the VDI service data, in which the watermark comprises a watermark code for identifying a watermark and a terminal code for identifying a client terminal.

The watermark may further include a time code that represents time information associated with using a VDI service screen of a client terminal.

The system for providing virtual desktop infrastructure may further include a watermark manager configured to manage the watermark code, the terminal code, and the time code, in which the watermark inserter inserts, into the VDI service data, a watermark including the watermark code, the terminal code, and the time code, which are provided by the watermark manager.

According to another exemplary embodiment, there is provided a method for providing a virtual desktop infrastructure (VDI) service, which includes: receiving a request for the VDI service from a client terminal; generating a watermark to be inserted into the requested VDI service data; inserting the generated watermark into the VDI service data; and transmitting the VDI service data, into which the watermark is inserted, to the client terminal, in which the generating of the watermark includes generating a watermark that includes a watermark code for identifying the watermark and a terminal code for identifying the client terminal.

The generating of the watermark may include generating a watermark that further includes a time code that represents time information associated with using the VDI service data of the terminal.

The transmitting may further include: compressing the VDI service data, into which the watermark is inserted; and encrypting the compressed VDI service data.

### BRIEF DESCRIPTION OF THE DRAWINGS

FIG. 1 is a block diagram illustrating an example of a system for providing a virtual desktop infrastructure (VDI) service according to an exemplary embodiment.

FIG. 2 is a block diagram illustrating an example of a server for providing a VDI service and a server for managing a watermark according to an exemplary embodiment.

FIG. 3 is a flowchart illustrating an example method of providing a VDI service according to an exemplary embodiment.

FIG. 4 is a block diagram illustrating an example of a communication terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

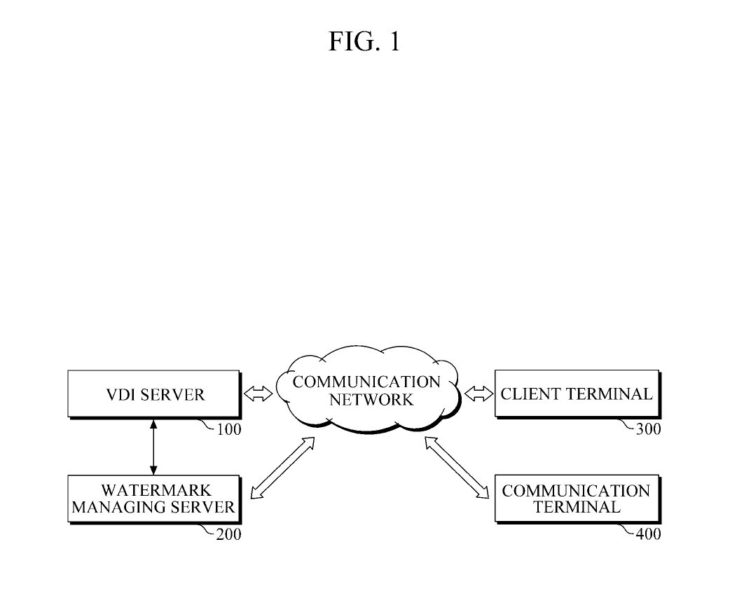

FIG. 1 is a block diagram illustrating an example of a system for providing a virtual desktop infrastructure (VDI) service according to an exemplary embodiment. As illustrated in FIG. 1, the system for providing a VDI service includes a VDI server 100 and a watermark managing server 200. Further, the system for providing a VDI service may include a client terminal 300, and may further include a communication terminal 400, in which data may be transmitted and received between the client terminal and the communication terminal through a communication network. According to an exemplary embodiment, the VDI server 100 and the watermark managing server 200 may be embodied as one element, or may be embodied as two separate elements as illustrated in FIG. 1, or may be embodied as more than two elements. In response to a request for a VDI service from the client terminal 300, the VDI server 100 may provide the VDI service to the client terminal 300. According to an exemplary embodiment, the VDI server 100 inserts a digital watermark into VDI service data to be provided to the client terminal 300. In a case where VDI service data leaks from the client terminal 300, the watermark including code information may trace the leak from the client terminal 300. Further, the watermark managing server 200 functions to assign and manage code information included in a watermark to be inserted into VDI service data.

The client terminal 300 may be a fixed terminal, such as a desktop computer, as well as a mobile terminal, such as a smartphone. The client terminal 300, as a VDI client terminal, may request the VDI server 100 for a VDI service, and may receive the requested service. Further, among code information included in a watermark, a terminal code for identifying the client terminal 300 may be assigned to the client terminal 300 from the watermark managing server. Further, as in the case of the client terminal 300, the communication terminal 400 may also be a fixed terminal, such as a desktop computer, as well as a mobile terminal, such as a smartphone. The communication terminal 400, as a watermark detecting terminal, includes an application for analyzing leaked VDI service data and identifying a terminal from which VDI service data is leaked.

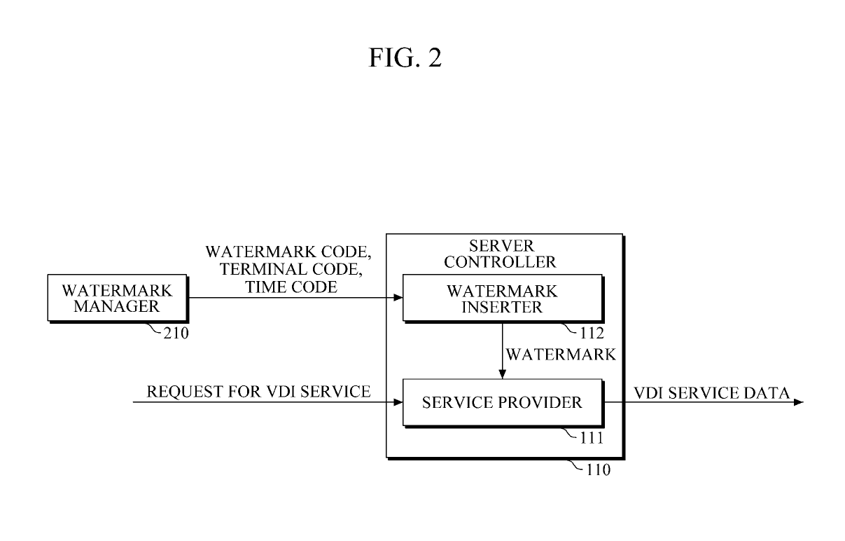

FIG. 2 is a block diagram illustrating an example of a server for providing a VDI service and a server for managing a watermark according to an exemplary embodiment. A server controller 110 may be included in a VDI server 100, and a watermark manager 210 may be included in a watermark managing server 200. The server controller 110 may be embodied as one or more hardware processors, and as a software module, may include a service provider 111 and a watermark inserter 112. Further, the watermark manager 210 may be embodied as one or more hardware processors in which a software managing module for assigning and managing a watermark may be installed.

The watermark manager 210 assigns and manages code information included in a watermark. According to an exemplary embodiment, code information may include a watermark code for identifying a watermark itself, and a terminal code for identifying a client terminal 300. Further, code information may further include a time code that represents time information associated with the use of VDI service data. Here, the time code may be time information at a point where the client terminal 300 accesses VDI service data. In addition, a user code for identifying a user of the client terminal 300 may be further included.

The server controller 110 may include the service provider 111 and the watermark inserter 112, in which in response to a request for VDI service from the client terminal 300, the service provider 111 may transmit the requested VDI service data to the client terminal 300. Here, the VDI service data may be a screen image of a server, which is a host. Further, the watermark inserter 112 generates a watermark to be inserted into VDI service data, and inserts the generated watermark into the VDI service data. The watermark inserter 112 may generate a watermark that includes code information including a watermark code, a terminal code, and a time code, which are managed by the watermark manager 210.

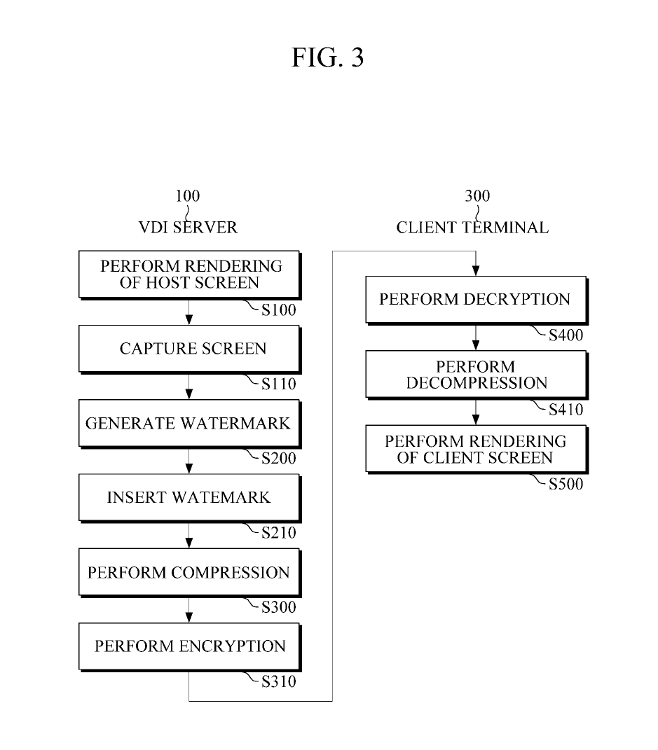

FIG. 3 is a flowchart illustrating an example method of providing a VDI service according to an exemplary embodiment. A VDI server 100 performs rendering of a VDI host screen in response to a request for a VDI service from a client terminal 300 in S100, and captures the resulting screen in S110. The VDI server 100 generates a digital watermark based on code information managed by the watermark managing server 22 in S200, and inserts the watermark generated on the captured screen in S210, in which the digital watermark is created in a noise form barely seen to a user. The VDI server 100 reduces data amount by compression so as to transmit bitmap images, which are the watermark-inserted VDI service data, through a communication network in S300, and performs encryption in S310 for security in a transmission section. The encrypted data is transmitted to the client terminal 300 through a communication network. Then, the client terminal 300 performs decryption of the transmitted VDI service data in S400, generates bitmap images by decompression in S410, and performs screen rendering in S500. Depending on provided service types, compression in S300, encryption in S310, decryption in S400, and decompression in S410 may be omitted.

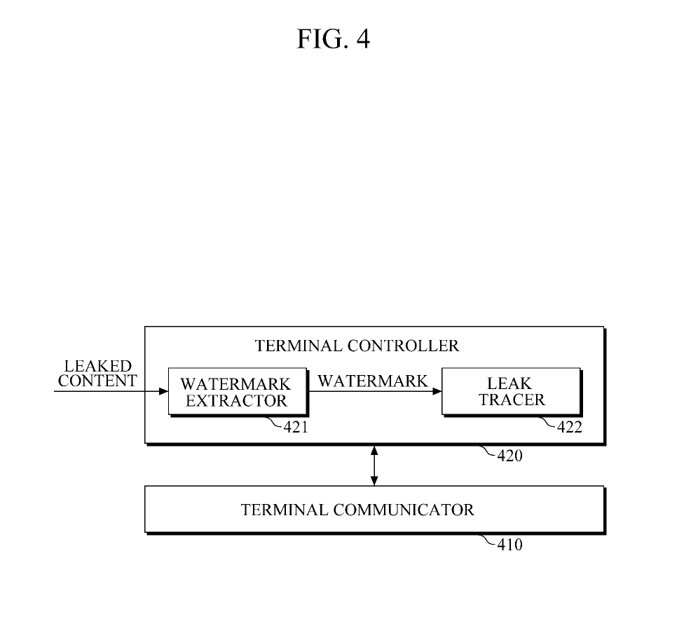

FIG. 4 is a block diagram illustrating an example of a communication terminal according to an exemplary embodiment. As illustrated in FIG. 4, the communication terminal 400 includes a terminal communicator 410 and a terminal controller 420. The terminal communicator 410 is used for communication with external devices, as is well known in the art, and the terminal controller 420 may include one or more processors, or may include a watermark extractor 420 and a leak tracer 422. The watermark extractor 421 receives leaked contents, and extracts code information included in a watermark from the received contents. The extracted code information includes at least one of a watermark code, a terminal code, a time code, and a user code. The leak tracer 422 may transmit the extracted code information to the VDI server 100 to request information about a leak suspect, and the information on the suspect received from the VDI server 100 may be displayed on a screen. Here, the information may be at least one of client terminal information and user information, where the client terminal information may be a telephone number, and the user information may be an identification number. As such, the information on the suspect may include personal information, and thus, it is advisable that only authorized persons use the communication terminal 400.

In a system and method for providing a VDI service, a digital watermark including code information is inserted into VDI service data to trace a suspect of data leakage, such that the code information may be extracted in leaked documents, and the suspect may be traced, thereby enhancing VDI security.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A system for providing a virtual desktop infrastructure (VDI) service, comprising:
a service provider configured to provide VDI service data to a client terminal; and
a watermark inserter configured to insert a watermark into the VDI service data,
wherein the watermark comprises a watermark code for identifying a watermark and a terminal code for identifying a client terminal.

2. The system of claim 1, wherein the watermark further comprises a time code that represents time information associated with using a VDI service screen of the client terminal.

3. The system of claim 1, further comprising a watermark manager configured to manage the watermark code, the terminal code, and the time code,
wherein the watermark inserter inserts, into the VDI service data, a watermark comprising the watermark code, the terminal code, and the time code, which are provided by the watermark manager.

4. A method for providing a virtual desktop infrastructure (VDI) service, comprising
receiving a request for the VDI service from a client terminal;
generating a watermark to be inserted into the requested VDI service data;
inserting the generated watermark into the VDI service data; and
transmitting the VDI service data, into which the watermark is inserted, to the client terminal,
wherein the generating of the watermark comprises generating a watermark that comprises a watermark code for identifying the watermark and a terminal code for identifying the client terminal.

5. The method of claim 4, wherein the generating of the watermark comprises generating a watermark that further comprises a time code that represents time information associated with using the VDI service data of the terminal.

6. The method of claim 4, wherein the transmitting further comprises:
compressing the VDI service data, into which the watermark is inserted; and
encrypting the compressed VDI service data.
